(19) United States
(12) Patent Application Publication
(10) Pub. No.: US 2025/0182199 A1
(43) Pub. Date: Jun. 5, 2025

(54) Method and System for Automated Loan Negotiation

(71) Applicant: Lendingkart Technologies Private Limited, Ahmedabad (IN)

(72) Inventors: Harshvardhan LUNIA, GJ (IN); Nitin SHIRALKAR, Hyderabad (IN); Dhanesh PADMANABHAN, Kolar (IN); Sudhanshu PRASAD, Bangalore (IN); Aditya Kumar PAL, Kanpur (IN)

(21) Appl. No.: 18/747,560

(22) Filed: Jun. 19, 2024

(30) Foreign Application Priority Data
Dec. 4, 2023 (IN) 202321082427

(51) Int. Cl. G06Q 40/03

(52) U.S. Cl. CPC G06Q 40/03

(57) ABSTRACT

A system for automated loan negotiation is provided. The system identifies that initial values of loan parameters such as an amount, tenure, an interest rate, and processing fee of a loan that are presented to a borrower of the loan are one of selected to be negotiated and ignored. Thus, the system iteratively determines modified values of the loan parameters based on at least one of a borrower profile of the borrower, various historical borrower profiles, desired values of loan parameters of the borrower, and various regulations set by a lending entity associated with the system. The modified values of the loan parameters are iteratively determined for a predetermined number of times or until the borrower accepts the modified values of the loan parameters. As a result, automated loan negotiation is implemented by the system.

### FIELD

Various embodiments of the present disclosure relate generally to loan negotiation. More particularly, various embodiments of the present disclosure relate to methods and systems for automated loan negotiation.

### BACKGROUND

Negotiation of crucial loan parameters such as loan amount, processing fee, interest rate, and tenure of the loan is a critical process involved in loan acquisition. Conventionally, the negotiation is cumbersome and inefficient as the negotiation occurs between analysts associated with a lending entity and a borrower of the loan, manually.

In light of the foregoing, there is a need for a technical solution that solves the above-abovementioned problem and facilitates efficient negotiation during loan acquisition.

### SUMMARY

Methods and systems for automated loan negotiation are provided substantially as shown in and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates a system environment for facilitating automated loan negotiation, in accordance with an exemplary embodiment of the present disclosure;

FIG. 2A represents a pictorial representation of an option to one of accept and reject a plurality of first values of a plurality of loan parameters of a loan rendered on a borrower device of the system environment of FIG. 1 to facilitate automated loan negotiation, in accordance with an exemplary embodiment of the present disclosure;

FIG. 2B represents a pictorial representation of an option to enter a plurality of second values of a plurality of loan parameters of the loan rendered on the borrower device of the system environment of FIG. 1 to facilitate automated loan negotiation, in accordance with an exemplary embodiment of the present disclosure;

FIG. 2C represents a pictorial representation of an option to one of accept and reject a plurality of third values of a plurality of loan parameters of the loan rendered on the borrower device 106 of the system environment 100 of FIG. 1 to facilitate automated loan negotiation, in accordance with an exemplary embodiment of the present disclosure;

FIGS. 3A-3E, collectively represent a flowchart 300 that illustrates a method (i.e., a process) for automated loan negotiation, in accordance with an exemplary embodiment of the present disclosure; and

FIG. 4 is a block diagram that illustrates a system architecture of a system for automated loan negotiation, in accordance with an exemplary embodiment of the disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

In an embodiment of the present disclosure, a method is disclosed. The method includes, identifying, by a processor of a system, whether a plurality of first values of a plurality of loan parameters associated with a loan, presented to a borrower are being one of (i) ignored and (ii) subjected to negotiation. The processor receives a plurality of second values of the plurality of loan parameters from a device of the borrower when the plurality of first values of the plurality of loan parameters presented to the borrower are subjected to negotiation. The method further includes iteratively determining, by the processor, to negotiate, a plurality of third values of the plurality of loan parameters. The plurality of third values of the plurality of loan parameters are iteratively determined until one of (i) the plurality of third values are accepted by the borrower and (ii) a number of times the determination of the plurality of third values performed is less than an iteration threshold value. The plurality of third values corresponding to each of the iteratively performed determinations are unique. The plurality of third values determined in each iteration are rendered to the borrower to enable the borrower to select one of (i) accept the plurality of third values and (ii) negotiate the plurality of third values. Upon the identification that the plurality of first values are subjected to negotiation and a return on asset (ROA) value for the plurality of second values being less than an ROA threshold value, a first determination of the iteratively performed determinations is based on the ROA threshold value, the plurality of second values of the plurality of loan parameters, a set of upper threshold values associated with the plurality of loan parameters, a set of lower threshold values associated with the plurality of loan parameters, a borrower profile of the borrower, and a plurality of borrower profiles of a plurality of historical borrowers stored in a memory element of the system. Upon the identification that the plurality of first values are ignored, a first determination of the iteratively performed determinations is based on the ROA threshold value, the set of upper threshold values associated with the plurality of loan parameters, the set of lower threshold values associated with the plurality of loan parameters, the borrower profile of the borrower, and the plurality of borrower profiles of the plurality of historical borrowers.

In another embodiment of the present disclosure, a system is disclosed. The system includes a memory element and a processor. The memory element is configured to store a plurality of borrower profiles of a plurality of historical borrowers. The processor is configured to identify whether a plurality of first values of a plurality of loan parameters associated with a loan, presented to a borrower are being one of (i) ignored and (ii) subjected to negotiation. The processor receives a plurality of second values of the plurality of loan parameters from a device of the borrower when the plurality of first values of the plurality of loan parameters presented to the borrower are subjected to negotiation. The processor is further configured to iteratively determine, to negotiate, a plurality of third values of the plurality of loan parameters. The plurality of third values of the plurality of loan parameters are iteratively determined until one of (i) the plurality of third values are accepted by the borrower and (ii) a number of times the determination of the plurality of third values performed is less than an iteration threshold value. The plurality of third values corresponding to each of the iteratively performed determinations are unique. The plurality of third values determined in each iteration are rendered to the borrower to enable the borrower to select one of (i) accept the plurality of third values and (ii) negotiate the plurality of third values. Upon the identification that the plurality of first values are subjected to negotiation and a return on asset (ROA) value for the plurality of second values being less than an ROA threshold value, a first determination of the iteratively performed determinations is based on the ROA threshold value, the plurality of second values of the plurality of loan parameters, a set of upper threshold values associated with the plurality of loan parameters, a set of lower threshold values associated with the plurality of loan parameters, a borrower profile of the borrower, and a plurality of borrower profiles of a plurality of historical borrowers stored in a memory element of the system. Upon the identification that the plurality of first values are ignored, a first determination of the iteratively performed determinations is based on the ROA threshold value, the set of upper threshold values associated with the plurality of loan parameters, the set of lower threshold values associated with the plurality of loan parameters, the borrower profile of the borrower, and the plurality of borrower profiles of the plurality of historical borrowers.

In some embodiments, the method further includes executing, by the processor, a first trained machine learning model based on the plurality of borrower profiles of the plurality of historical borrowers and the borrower profile of the borrower, to filter a set of look-alike borrowers for the borrower. The method further includes obtaining a set of boundary values of the plurality of loan parameters, based on the set of look-alike borrowers, by the processor. The method further includes providing the set of boundary values, the ROA threshold value, the set of upper threshold values, the set of lower threshold values, and the plurality of second values, to a second trained machine learning model associated with the system, as an input, by the processor. The method further includes receiving, by the processor, multiple plurality of third values of the plurality of loan parameters as an output from the second trained machine learning model. The second trained machine learning model generates the multiple plurality of third values based on the input received from the processor. The method further includes identifying, by the processor, the plurality of third values from the multiple plurality of third values based on the plurality of second values. The identified plurality of third values are least deviated from the plurality of second values among the multiple plurality of third values.

In some embodiments, the method further includes executing, by the processor, a first trained machine learning model based on the plurality of borrower profiles of the plurality of historical borrowers and the borrower profile of the borrower, to filter a set of look-alike borrowers for the borrower. The method further includes obtaining the set of boundary values of the plurality of loan parameters, based on the set of look-alike borrowers by the processor. The method further includes providing the set of boundary values, the ROA threshold value, the set of upper threshold values, and the set of lower threshold values, to the second trained machine learning model associated with the system, as the input by the processor. The method further includes receiving, by the processor, multiple plurality of third values of the plurality of loan parameters as the output from the second trained machine learning model. The second trained machine learning model generates the multiple plurality of third values based on the input received from the processor. The method further includes identifying, by the processor, the plurality of third values from the multiple plurality of third values based on the iteration threshold value and an iteration count value. The iteration count value of each determination of the iteratively performed determinations indicates an iteration number associated with the corresponding iteration.

In some embodiment, the method further includes identifying, by the processor, the plurality of third values among the multiple plurality of third values based on the iteration threshold value and the iteration count value.

In some embodiment, the method further includes receiving, by the processor, the plurality of second values from the borrower device of the borrower when the plurality of first values of the plurality of loan parameters presented to the borrower are subjected to negotiation. The received plurality of second values are within the set of upper threshold values associated with the plurality of loan parameters and the set of lower threshold values associated with the plurality of loan parameters. The set of upper threshold values and the set of lower threshold values are based on the borrower profile of the borrower.

In some embodiments, the plurality of loan parameters includes at least two of a loan amount, a tenure of the loan, an interest rate for the loan, and a processing fee associated with the loan.

In some embodiments, the method further includes, determining, by the processor, the iteration threshold value based on the plurality of borrower profiles of the plurality of historical borrowers and the borrower profile of the borrower.

In some embodiment, the method further includes determining, by the processor, an equated monthly installment (EMI) of the loan for the plurality of third values upon the determination of the plurality of third values. The method further includes presenting, by the processor, the EMI along with the plurality of third values to the borrower. The method further includes rendering, by the processor, an option for the borrower to select one of (i) accept the plurality of third values and (i) negotiate the plurality of third values.

In some embodiments, the borrower profile of the borrower includes a set of profile parameters. The set of profile parameters includes one or more of a cash flow statement, business type, credit history, industry type, demographics, and credit score.

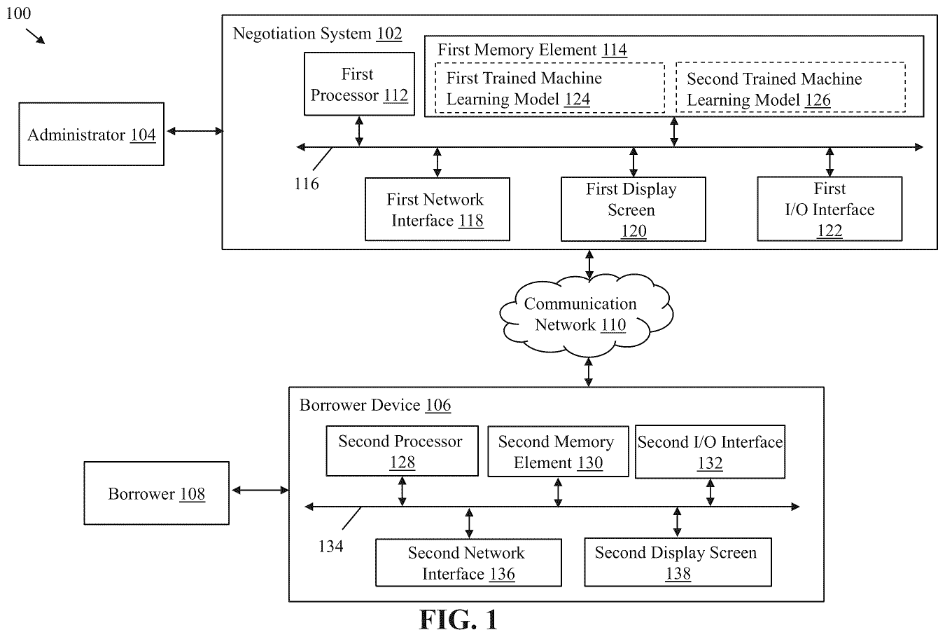

FIG. 1 is a block diagram that illustrates a system environment 100 for facilitating automated loan negotiation, in accordance with an exemplary embodiment of the present disclosure. The system environment 100 includes a negotiation system 102, an administrator 104, and a borrower device 106 associated with a borrower 108. The negotiation system 102 and the borrower device 106 may communicate with each other by way of a communication network 110.

The negotiation system 102 is maintained by a lending entity for facilitating automated loan negotiation. A lending entity refers to an entity that provides financial resources in the form of loans, to individuals, businesses, or other entities in exchange for an agreement of repayment of the loan with interest. A loan is a financial arrangement in which the lending entity such as a financial institution, provides a certain amount of money referred to as a loan amount to another party, known as a borrower (such as the borrower 108). The borrower has to repay the loan amount over a specified period, with interest and other fees such as processing fees, to the lending entity. Examples of the lending entity may include, but are not limited to, a financial institution, a credit union, a mortgage company, an online lending platform, an individual lender, or the like.

The negotiation system 102 includes suitable logic, circuitry, interfaces, and/or code, executable by the circuitry for performing various functions to facilitate automated loan negotiation. Examples of the negotiation system 102 may include, but are not limited to, an automated teller machine (ATM), a kiosk, a computer, a laptop, and a network of computer systems. The negotiation system 102 may be also realized through various web-based technologies such as, but not limited to, a Java web framework, a .NET framework, a PHP framework, or any other web application framework. The administrator 104 is associated with the lending entity. The negotiation system 102 may receive one or more inputs from the administrator 104 to perform one or more operations. The negotiation system 102 may include a first processor 112, a first memory element 114, a first network interface 118, a first display screen 120, and a first I/O interface 122. The first processor 112, the first memory element 114, the first network interface 118, the first display screen 120, and the first I/O interface 122 may communicate with each other via a first communication bus 116. The first communication bus 116 may be configured to allow data such as electrical signals and electromagnetic signals to be transferred between the first processor 112, the first memory element 114, the first I/O interface 122, the first network interface 118, and the first display screen 120. Examples of the first communication bus 116 may include, but are not limited to a data bus, an address bus, and a control bus.

The borrower device 106 associated with the borrower 108 is a computing device of the borrower 108. The borrower device 106 includes suitable logic, circuitry, interfaces, and/or code, executable by the circuitry for performing various operations. The borrower 108 refers to an entity that has applied for a loan at the lending entity. In an example, the borrower 108 applies for the loan, online via a loan application installed on the borrower device 106 or a web application accessed through the borrower device 106. The loan application and the web application are provided by the lending entity. In another example, the borrower 108 applies for the loan by visiting the lending entity. In an embodiment, a borrower profile of the borrower 108 that includes a set of profile parameters of the borrower 108 is provided to the lending entity while applying for the loan. In another embodiment, the borrower profile of the borrower 108 may be obtained by the lending entity when the borrower 108 applies for the loan. The set of profile parameters includes one or more of a cash flow statement, business type, credit history, industry type, demographics, and credit score. Examples of the borrower device 106 may include but are not limited to, a mobile phone, a computer, a laptop, a smartphone, a tablet, and a phablet. The borrower device 106 may include a second processor 128, a second memory element 130, a second I/O interface 132, a second network interface 136, and a second display screen 138.

The communication network 110 facilitates communication between the borrower device 106 and the negotiation system 102 associated with the lending entity. Examples of the communication network 110 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. The entities in the system environment 100 may connect to the communication network 110 in accordance with various wired and wireless communication protocols, such as Transmission Control Protocol and Internet Protocol (TCP/IP), User Datagram Protocol (UDP), Long Term Evolution (LTE) communication protocols, or any combination thereof.

Referring back to the negotiation system 102, the first processor 112 of the negotiation system 102 includes suitable logic, circuitry, interfaces, and/or code executable by the circuitry for facilitating automated loan negotiation. Examples of the first processor 112 may include, but are not limited to, an application-specific integrated circuit (ASIC) processor, a reduced instruction set computing (RISC) processor, a complex instruction set computing (CISC) processor, and a field-programmable gate array (FPGA). It will be apparent to a person of ordinary skill in the art that the first processor 112 may be compatible with multiple operating systems. The first processor 112 may be configured to receive the set of profile parameters of the borrower 108. In an embodiment, the set of profile parameters provided by the borrower 108 via the loan application or the web application is received by the first processor 112. In another embodiment, the set of profile parameters obtained by the lending entity is provided to the first processor 112 by the administrator 104 via the first I/O interface 122. Further, the first processor 112 is configured to determine a plurality of first values of the plurality of loan parameters of the loan based on the set of profile parameters of the borrower 108 and the return on asset (ROA) of the loan. The plurality of loan parameters of the loan may include at least two of a loan amount, a tenure of the loan, an interest rate for the loan, and a processing fee associated with the loan. The ROA refers to a profit to be earned by the lending entity for lending the loan. The ROA for the loan is computed based on total costs associated with the loan and total income to be earned from the loan. The total costs include actual cost and projected cost. The actual cost includes cost-of-fund, cost-of-customer acquisition, cost of delivery, fixed costs, and collection costs. The projected cost includes cost-of-credit, interest loss, or the like. The total income includes revenue from interest income, the processing fee, and cross-sell revenue. The cross-sell revenue refers to the additional revenue generated by selling related or complementary products or services to the borrower 108. The cost of funds is the amount of money a company spends to run operations. Customer acquisition cost (CAC) is the total cost of acquiring a new customer which includes the cost of sales and marketing efforts, as well as property or equipment.

Although it is described that the plurality of first values are determined by the first processor 112, the scope of the present disclosure is not limited to it. In other embodiments, the plurality of first values of the plurality of loan parameters associated with the loan may be determined by another system that is associated with the lending entity.

The first processor 112 is further configured to present the plurality of first values of the plurality of loan parameters on the second display screen 138 of the borrower device 106 in response to receiving the set of profile parameters. In an example, the plurality of first values include $50,000 as the loan amount, 36 months as the loan tenure, 12% as the interest rate for the loan, and $1600 as the processing fee. The first processor 112 renders an option to the borrower 108 to one of accept the plurality of first values and negotiate the plurality of first values, while presenting the plurality of first values on the second display screen 138. Further, the first processor 112 is configured to identify whether the plurality of first values of the plurality of loan parameters is one of accepted and subjected to negotiation. Additionally, the option to one of accept the plurality of first values and negotiate the plurality of first values is rendered for a predetermined period of time (such as 24 hours). When the option to one of accept the plurality of first values and negotiate the plurality of first value is not selected by the borrower 108 during the predetermined period of time, the plurality of first values are considered to be ignored by the borrower 108.

Automated negotiation begins when the first processor 112 identifies that the plurality of first values are one of being subjected to negotiation and ignored. When the first processor 112 identifies that the plurality of first values are subjected to negotiation, the first processor 112 renders an option to the borrower 108 to enter a plurality of second values of the plurality of loan parameters. Additionally, the first processor 112 indicates the borrower 108 to enter the plurality of second values that are within a set of lower threshold values associated with the plurality of loan parameters and a set of upper threshold values associated with the plurality of loan parameters. In an embodiment, the first processor 112 is configured to determine the set of upper threshold values and the set of lower threshold values based on the set of profile parameters of the borrower 108. In another embodiment, the set of upper threshold values and the set of lower threshold values are provided to the first processor 112 by the administrator 104. The first processor 112 receives the plurality second values that are within the set of upper threshold values and the set of lower threshold values. In an example, the plurality of second values include $50,000 as the loan amount, 36 months as the tenure, 7% as the interest rate, and $1000 as the processing fee. The plurality of second values are entered through the second I/O interface 132. The first processor 112 receives the plurality of second values of the plurality of loan parameters from the borrower device 106.

The first processor 112 is further configured to compute the ROA of the loan based on the plurality of second values. Further, the first processor 112 identifies whether the ROA of the loan is less than an ROA threshold value. The ROA threshold value is unique for a specific borrower based on the set of profile parameters of the borrower 108 and a pricing scheme for the loan. The pricing scheme depends on at least one of a type of the loan (such as term loan, overdraft loan, and the like), cost structure of the lending entity, and the like. The type of the loan may be determined by the first processor 112 based on the borrower profile of the borrower 108.

The first processor 112 is configured to execute a first trained machine learning model 124 based on the identification that one of the plurality of first values are ignored and the ROA of the loan based on the plurality of second values is less than the ROA threshold value. The first trained machine learning model 124 is executed based on a plurality of borrower profiles of the plurality of historical borrowers and the borrower profile of the borrower 108 to filter out a set of look-alike borrowers. The plurality of borrower profiles of the plurality of historical borrowers may include the set of profile parameters for each borrower of the plurality of historical borrowers. The set of look-alike borrowers refers to a group of borrowers who are similar to the borrower 108. In an example, the plurality of historical borrowers may include the borrower 108.

During the execution of the first trained machine learning model, the first processor 112 processes the profile of the borrower 108 to extract first values of the set of profile parameters. Further, the first processor 112 provides the first values of the set of profile parameters as an input to the first trained machine learning model 124. The first trained machine learning model 124 generates a confidence score for each borrower profile of the historical borrowers stored in the first memory element 114 based on a degree of matching between the first values of the set of profile parameters and second values of the set of profile parameters associated with the corresponding borrower profile. Further, the first processor 112 receives the confidence score for each borrower profile stored in the first memory element 114. The first processor 112 filters those historical borrowers as the look-alike historical borrowers for which the confidence score of the borrower profile exceeds a threshold value. In an embodiment, the first processor 112 may be configured to train the first machine learning model to generate the first trained machine learning model 124 based on training data set and testing dataset that are stored in the first memory element 114. The training dataset and the testing dataset may include the borrower profiles of the plurality of historical borrowers. Examples of the first trained machine learning model 124 may include, but are not limited to, a convolutional neural network (CNN), a recurrent neural network (RNN), a radial basis functional neural network, a deep neural network model, a long short-term memory (LSTM) model, or the like.

The first processor 112 is further configured to obtain a set of boundary values of the plurality of loan parameters, based on the set of look-alike borrowers. In other words, the first processor 112 obtains the set of boundary values based on set of borrower profiles of the set of look-alike borrowers. Each of the set of borrower profiles indicates a set of historical loans lent to a corresponding look-alike borrower. The set of historical loans includes values of various loan parameters. The set of boundary values define upper threshold value and lower threshold value for each of the plurality of loan parameters based on the set of look-alike borrowers. In an example, the set of boundary values includes $5000 as the lower threshold value and $2,00,000 as the upper threshold value for the loan amount, 6 months as the lower threshold value, and 240 months as the upper threshold value for the loan tenure, 8% as the lower threshold value and 24% as the upper threshold value for the interest rate, and $200 as the lower threshold value and $5000 as the upper threshold value for the processing fees.

The first processor 112 is configured to provide the set of boundary values, the ROA threshold value, the set of upper threshold values of the plurality of loan parameters, the set of lower threshold values of the plurality of loan parameters, and the plurality of second values to a second trained machine learning model 126 as an input based on the identification that the option to negotiate is selected by the borrower 108 and the ROA of the loan is less than the ROA threshold value.

The second trained machine learning model 126 receives the set of boundary values, the ROA threshold value, the set of upper threshold values, the set of lower threshold values, and the plurality of second values from the first processor 112 as an input. Upon the receipt of the input, the second trained machine learning model 126 generates multiple plurality of third values of the plurality of loan parameters as an output. In an example, the multiple plurality of third values includes a first plurality of third values, a second plurality of third values, a third plurality of third values, and may be until a tenth plurality of third values.

The second trained machine learning model 126 provides the generated multiple plurality of third values to the first processor 112. The first processor 112 receives the multiple plurality of third values of the plurality of loan parameters as an output from the second trained machine learning model 126. Upon receiving the multiple plurality of third values from the second trained machine learning model, the first processor 112 identifies one of the plurality of third values to be presented to the borrower based on the plurality of second values. The first processor 112 identifies the plurality third values which deviates the least from the plurality second values of the plurality of loan parameters. In other words, the first processor 112 determines the plurality of third values of the plurality of loan parameters based on the ROA threshold value, a set of upper threshold values of the plurality of loan parameters, a set of lower threshold values of the plurality of loan parameters, the plurality of second values, the borrower profile of the borrower and the plurality of borrower profiles of the plurality of historical borrowers. In an example, the plurality of third values include $50,000 as the loan amount, 48 months as the tenure, 10% as the rate of interest, $1400 as the processing fee.

The first processor 112 is configured to provide the set of boundary values, the ROA threshold value, the set of upper threshold values of the plurality of loan parameters, and the set of lower threshold values of the plurality of loan parameters to the second trained machine learning model 126 as an input based on the identification that the plurality of first values are ignored by the borrower 108. The second trained machine learning model 126 generates the multiple plurality of third values as an output based on the received input. The second trained machine learning model 126 then provides the generated multiple plurality of third values to the first processor 112. The first processor 112 receives the multiple plurality of third values of the plurality of loan parameters as an output from the second trained machine learning model 126. Further, the first processor 112 identifies one of the plurality of third values from the multiple plurality of third values to be presented to the borrower 108 based on an iteration threshold value and an iteration count value. The iteration threshold value refers to a number of times the first processor 112 has to render an option to negotiate the plurality of loan parameters to the borrower 108. In an embodiment, the first processor 112 may determine the iteration threshold value based on the plurality of borrower profiles of the plurality of historical borrowers and the borrower profile of the borrower. In another embodiment, the iteration threshold value may be provided by the administrator 104 based on the borrower profile of the borrower 108. The iteration count value is initially set to zero. The iteration count value indicates an iteration number associated with determining the plurality of third values. When the first processor 112 identifies that the plurality of first values are one of subjected to negotiation and ignored, the iteration count value is incremented by one value. In other words, the first processor 112 determines the plurality of third values of the plurality of loan parameters based on the ROA threshold value, a set of upper threshold values of the plurality of loan parameters, a set of lower threshold values of the plurality of loan parameters, the borrower profile of the borrower and the plurality of borrower profiles of the plurality of historical borrowers. Examples of the second trained machine learning model 126 may include, but are not limited to, a convolutional neural network (CNN), a recurrent neural network (RNN), a radial basis functional neural network, a deep neural network model, a long short-term memory (LSTM) model, or the like.

The first processor 112 is further configured to determine an equated monthly installment (EMI) of the loan based on the plurality of third values. The equated monthly installment (EMI) refers to an amount to be paid by borrower 108 to the lending entity before a specified date in each calendar month to repay the loan.

The first processor 112 is further configured to render the plurality of third values of the plurality of loan parameters and the EMI to the borrower 108 on the borrower device 106. The first processor 112 further renders an option to the borrower 108 to select one of accept the plurality of third values and negotiate the plurality of third values. The first processor 112 increments the iteration count value by one value when the plurality of third values are identified to be one of subjected to negotiation and ignored. When the first processor 112 identifies that the plurality of third values are subjected to negotiation by the borrower 108, the first processor 112 determines a plurality of fourth values of the plurality of loan parameters in a similar manner as the determination of the plurality of third values. When the first processor 112 identifies that the plurality of third values are ignored by the borrower 108, the first processor 112 identifies one of the multiple plurality of third values as the plurality of fourth value based on the iteration threshold value and the iteration count value. Further, the first processor 112 renders the plurality of fourth values of the plurality of loan parameters to the borrower 108 on the borrower device 106 along with an option to the borrower 108 to select one of accept the plurality of fourth values and negotiate the plurality of fourth values.

The first processor 112 iteratively determines a plurality of modified values of the plurality of loan parameters each time based on the identification that the presented plurality of values of the plurality of loan parameters are subjected to negotiation or ignored until the borrower 108 accepts the plurality of modified values or a number of times the determination of the plurality of third values performed is less or equal to the iteration threshold value. The plurality of modified values corresponding to each of the iteratively performed determinations are unique. In an example, the plurality of third values corresponds to the plurality of modified values when the iteration count value is one. In other words, the first processor 112 iteratively determines the plurality of third values of the plurality of loan parameters each time based on the identification that the plurality of first values of the plurality of loan parameters are subjected to negotiation or ignored until the borrower 108 accepts the plurality of third values or a number of times the determination of the plurality of third values performed is less or equal to the iteration threshold value. The iteration count value of each determination of the iteratively performed determinations indicates the iteration number associated with the corresponding iteration.

Prior to receiving the set of profile parameters of the borrower 108, the first processor 112 is configured to train a first machine learning model and a second machine learning model to obtain the first trained machine learning model and the second trained machine learning model 126, respectively. The first machine learning model and the second machine learning model are trained based on the plurality of borrower profiles of the plurality of historical borrowers. The training dataset and the testing dataset may include the profile parameters of the historical borrowers. Examples of the first trained machine learning model 124 and the second trained machine learning model 126 may include, but are not limited to, a convolutional neural network (CNN), a recurrent neural network (RNN), a radial basis functional neural network, a deep neural network model, a long short-term memory (LSTM) model, or the like.

The first memory element 114 may include suitable logic, circuitry, and interfaces that may be configured to store, therein, the plurality of borrower profiles of the plurality of historical borrowers. Each of the plurality of borrower profiles includes the set of profile parameters of a corresponding borrower and the set of historical loans lent to the corresponding borrower. The first memory element 114 may further be configured to store one or more instructions, which when executed by the first processor 112 cause the first processor 112 to perform various operations for facilitating automated loan negotiation. Further, the first memory element 114 is configured to store the first trained machine learning model 124 and the second trained machine learning model 126.

Examples of the first memory element 114 may include, but are not limited to, random-access memory (RAM), read-only memory (ROM), a removable storage drive, a hard disk drive (HDD), a flash memory, a solid-state memory, or the like. It will be apparent to a person skilled in the art that the scope of the disclosure is not limited to realizing the first memory element 114 in the negotiation system 102, as described herein. In other embodiments, the first memory element 114 may be realized in the form of a database or a cloud storage working in conjunction with the first processor 112, without deviating from the scope of the disclosure.

The first I/O interface 122 includes suitable logic, circuitry, and/or interfaces that are configured to perform one or more operations. The first I/O interface 122 may include input devices that are configured to operate under the control of the first processor 112 by way of the first communication bus 116. The first I/O interface 122 enables the administrator 104 to provide various inputs to facilitate automated loan negotiation. Examples of the input devices may include a universal serial bus (USB) port, an Ethernet port, a real or virtual keyboard, a mouse, a joystick, a touch screen, a stylus, a microphone, and the like. Examples of the output devices may include a speaker, headphones, the first display screen 120, a universal serial bus (USB) port, an Ethernet port, and the like.

The first display screen 120 includes suitable logic, circuitry, and/or interfaces that are configured to perform one or more operations. The first display screen 120 may be configured to display the plurality of first values, the plurality of second values, and the plurality of third values. Examples of the first display screen 120 may include, but are not limited to liquid crystal display (LCD), light-emitting diode (LED) display, organic LED (OLED) display, touchscreen display, Active-Matrix Organic LED (AMOLED) display, or the like.

The first network interface 118 includes suitable logic, circuitry, interfaces, and/or code, executable by the circuitry, to transmit and receive data over the communication network 110 using one or more communication network protocols. The first network interface 118 transmits and receives communication requests and responses from various elements in the system environment 100 through the communication network 110. Examples of the first network interface 118 may include but are not limited to, an antenna, a radio frequency network interface, a wireless network interface, a Bluetooth network interface, an ethernet port, a Universal Serial Bus (USB) port, or any other device configured to transmit and receive data.

The second display screen 138 includes suitable logic, circuitry, and/or interfaces that are configured to perform one or more operations. The second display screen is configured to display the plurality of first values and the plurality of third values, and the option to one of accept and negotiate the plurality of first values and the plurality of third values. Examples of the second display screen 138 may include, but are not limited to liquid crystal display (LCD), light-emitting diode (LED) display, organic LED (OLED) display, touchscreen display, Active-Matrix Organic LED (AMOLED) display, or the like.

The second processor 128 of the borrower device 106 includes suitable logic, circuitry, interfaces, and/or code executable by the circuitry for performing various operations. The second processor 128 may be configured to render a graphical user interface on the borrower device 106. The graphical user interface is manipulated by the borrower 108 at the borrower device 106 to submit a loan application and participate in the automated loan negotiation. Examples of the second processor 128 may include, but are not limited to, an application-specific integrated circuit (ASIC) processor, a reduced instruction set computing (RISC) processor, a complex instruction set computing (CISC) processor, and a field-programmable gate array (FPGA). It will be apparent to a person of ordinary skill in the art that the first processor 112 may be compatible with multiple operating systems.

The second memory element 130 is configured to store the loan application for facilitating automated loan negotiation. The second memory element 130 may further be configured to store one or more instructions, which when executed by the second processor 128 cause the second processor 128 to perform various operations. Examples of the second memory element 130 may include, but are not limited to, random-access memory (RAM), read-only memory (ROM), a removable storage drive, a hard disk drive (HDD), a flash memory, a solid-state memory, or the like. It will be apparent to a person skilled in the art that the scope of the disclosure is not limited to realizing the second memory element 130 in the negotiation system 102, as described herein. In other embodiments, the first memory element 114 may be realized in the form of a database or a cloud storage working in conjunction with the second processor 128, without deviating from the scope of the disclosure.

The second I/O interface 132 includes suitable logic, circuitry, and/or interfaces that are configured to perform one or more operations. The second I/O interface 132 may include input devices that are configured to operate under the control of the second processor 128 by way of the second communication bus 134. The second I/O interface 132 enables the borrower 108 select one of the options to accept the plurality of first values and negotiate the plurality of first values. Additionally, the second I/O interface 132 enables the borrower 108 to enter the plurality of second values. Examples of the input devices may include a universal serial bus (USB) port, an Ethernet port, a real or virtual keyboard, a mouse, a joystick, a touch screen, a stylus, a microphone, and the like. Examples of the output devices may include a speaker, headphones, the second display screen 138, a universal serial bus (USB) port, an Ethernet port, and the like.

The second network interface 136 includes suitable logic, circuitry, interfaces, and/or code, executable by the circuitry, to transmit and receive data over the communication network 110 using one or more communication network protocols. The second network interface 136 transmits and receives communication requests and responses from various elements in the system environment 100 through the communication network 110. Examples of the second network interface 136 may include but are not limited to, an antenna, a radio frequency network interface, a wireless network interface, a Bluetooth network interface, an ethernet port, a Universal Serial Bus (USB) port, or any other device configured to transmit and receive data.

The second display screen 138 includes suitable logic, circuitry, and/or interfaces that are configured to perform one or more operations. The second display screen 138 is configured to display the plurality of first values and the plurality of third values, and the option to one of accept and negotiate the plurality of first values and the plurality of third values. Examples of the second display screen 138 may include, but are not limited to liquid crystal display (LCD), light-emitting diode (LED) display, organic LED (OLED) display, touchscreen display, Active-Matrix Organic LED (AMOLED) display, or the like.

In operation, the first processor 112 presents the plurality of first values of the plurality of loan parameters to the borrower 108 and renders an option to one of accept and negotiate the plurality of first values. The option to one of accept and negotiate the plurality of first values is provided for the predetermined time period. When the borrower 108 does not select one of the options in the predetermined time period, the plurality of first values are considered to be ignored. The first processor 112 increments the iteration count value which was initially set to zero by one value when the plurality of first values are identified to be one of subjected to negotiation and ignored. When the borrower 108 selects the option to negotiate the plurality of first values, the first processor 112 renders the option to the borrower 108 on the borrower device 106 to enter the plurality of second values of the plurality of loan parameters. The first processor 112 indicates the borrower 108 to enter the plurality of second values within the set of lower threshold values associated with the plurality of loan parameters and the set of upper threshold values associated with the plurality of loan parameters.

Upon entering the plurality of second values by the borrower 108, the first processor 112 receives the plurality of second values and computes the ROA of the loan based on the plurality of second values. Further, the first processor 112 identifies whether the computed ROA is less than the ROA threshold value.

The first processor 112 further executes the first trained machine learning model 124 based on the identification that one of the plurality of first values are ignored and the ROA of the loan based on the plurality of second values is less than the ROA threshold value. The first trained machine learning model 124 is executed based on the plurality of borrower profiles of the plurality of historical borrowers and the borrower profile of the borrower 108 to filter out the set of look-alike borrowers.

Upon the execution of the first trained machine learning model 124, the first processor 112 obtains the set of boundary values of the plurality of loan parameters, based on the set of look-alike borrowers. The first processor 112 after obtaining the boundary values, provides the boundary values to the second trained machine learning model along with the ROA threshold value, the set of upper threshold values of the plurality of loan parameters, the set of lower threshold values of the plurality of loan parameters, and the plurality of second values to the second trained machine learning model 126 upon the identification that the plurality of first values are subjected to negotiation and the ROA value for the plurality of second values being less than the ROA threshold value.

The second trained machine learning model 126 receives the set of boundary values, the ROA threshold value, the set of upper threshold values, the set of lower threshold values, and the plurality of second values from the first processor 112 as the input. Upon the receipt of the input, the second trained machine learning model 126 generates multiple plurality of third values of the plurality of loan parameters as the output. The second trained machine learning model 126, provides the generated multiple plurality of third values to the first processor 112 for further processing. The first processor 112 receives the multiple plurality of third values from the second trained machine learning model 126 as the output. Upon receiving the multiple plurality of third values from the second trained machine learning model, the first processor 112 identifies one of the plurality of third values to be presented to the borrower 108 based on the plurality of second values. The first processor 112 identifies the plurality third values which deviates the least from the plurality second values of the plurality of loan parameters. In other words, the first processor 112 determines the plurality of third values of the plurality of loan parameters based on the ROA threshold value, the set of upper threshold values of the plurality of loan parameters, the set of lower threshold values of the plurality of loan parameters, the plurality of second values, the borrower profile of the borrower 108 and the plurality of borrower profiles of the plurality of historical borrowers.

The first processor 112 will provide the set of boundary values, the ROA threshold value, the set of upper threshold values of the plurality of loan parameters, and the set of lower threshold values of the plurality of loan parameters to the second trained machine learning model 126 as the input based on the identification that the plurality of first values are being ignored by the borrower 108. The second trained machine learning model 126 generates the multiple plurality of third values as the output based on the received input. The second trained machine learning model 126 then provides the generated multiple plurality of third values to the first processor 112. The first processor 112 receives the multiple plurality of third values of the plurality of loan parameters as the output from the second trained machine learning model 126. Further, the first processor 112 identifies one of the plurality of third values from the multiple plurality of third values to be presented to the borrower 108 based on the iteration threshold value and the iteration count value.

The first processor 112 upon the identification of the plurality of third values among the multiple plurality of third values, will determine the EMI of the identified plurality of third values. The determined EMI will then be presented to the borrower 108 on the second display screen 138 of the borrower device 106 along with the plurality of third values. The first processor 112 further renders an option to the borrower 108 to select one of accept the plurality of third values and negotiate the plurality of third values. When the first processor 112 identifies that the option to negotiate the plurality of third values is selected by the borrower 108, the first processor 112 determines the plurality of fourth values of the plurality of loan parameters. The determination of the plurality of fourth values is similar to the determination of plurality of third values. When the first processor 112 identifies that one of the options to accept and negotiate is not selected by the borrower 108 within the predetermined time period, the first processor 112 identifies one of the multiple plurality of third values as the plurality of fourth value based on the iteration threshold value and the iteration count value. Further, the first processor 112 renders the plurality of fourth values of the plurality of loan parameters to the borrower 108 on the borrower device 106 along with the option to the borrower 108 to select one of accept the plurality of fourth values and negotiate the plurality of fourth values.

The first processor 112 iteratively determines the plurality of modified values of the plurality of loan parameters each time based on the identification that the presented plurality of values of the plurality of loan parameters are subjected to negotiation or ignored until the borrower 108 accepts the plurality of modified values or the number of times the determination of the plurality of third values performed is less or equal to the iteration threshold value. In an example, the plurality of third values is the plurality of modified values.

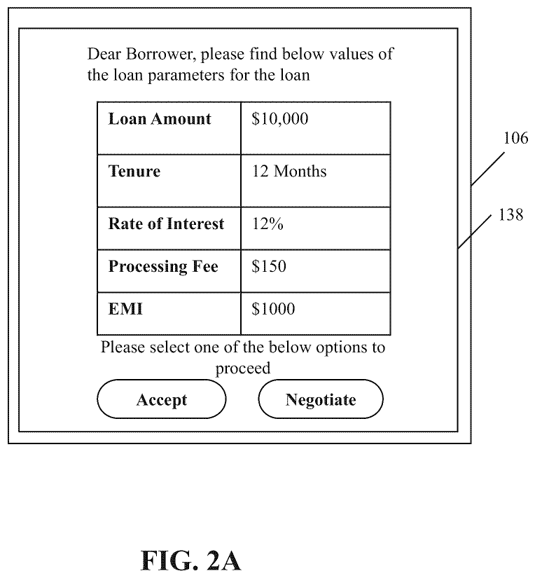

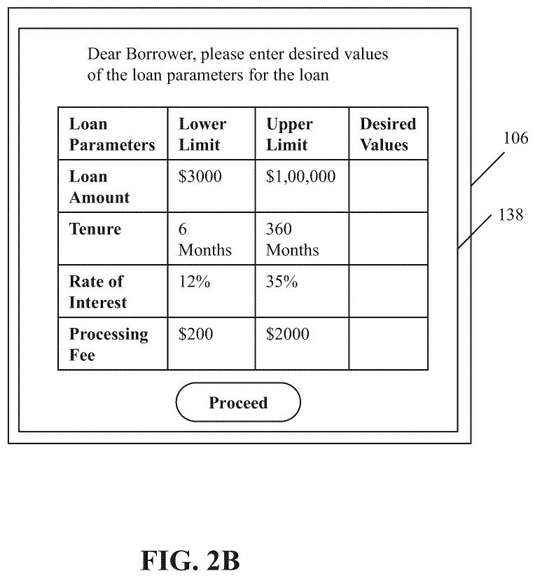

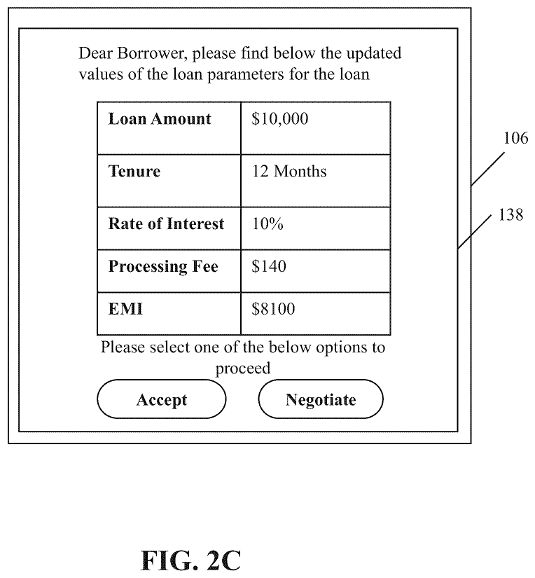

FIG. 2A represents a pictorial representation of the option to one of accept and reject the plurality of first values of the plurality of loan parameters of the loan rendered on the borrower device 106 of the system environment 100 of FIG. 1 to facilitate automated loan negotiation, in accordance with an exemplary embodiment of the present disclosure.

The option to one of accept and reject the plurality of first values of the plurality of loan parameters of the loan is rendered on the second display screen 138 of the borrower device 106 by the first processor 112. The option is rendered on the second display screen 138 of the borrower device 106 when the borrower 108 applies for the loan at the lending entity. A message that indicates “Dear Borrower, please find below values of the loan parameters for the loan” is displayed on the second display screen 138. In a non-limiting example, the plurality of first values of the plurality of loan parameters that include $10,000/-as the loan amount, 12 months as the tenure of the loan, 12% of the loan amount as the rate of interest per annum, and $150/-as the processing fee are displayed on the second display screen 138. Additionally, $900/-as the EMI for the loan is displayed on the second display screen 138. Further, the option to one of accept and negotiate the plurality of first values of the plurality of loan parameters is displayed on the second display screen 138. One of the options is selected by the borrower 108 through the second I/O interface 132.

FIG. 2B represents a pictorial representation of the option to enter the plurality of second values of the plurality of loan parameters of the loan rendered on the borrower device 106 of the system environment 100 of FIG. 1 to facilitate automated loan negotiation, in accordance with an exemplary embodiment of the present disclosure.

The option to enter the plurality of second values of the plurality of loan parameters of the loan is rendered on the second display screen 138 of the borrower device 106 by the first processor 112. The option is displayed based on the identification that the plurality of first values of the plurality of loan parameters are being negotiated. A message that indicates “Dear Borrower, please enter desired values of the loan parameters for the loan” is displayed on the second display screen 138. Additionally, the set of lower threshold values and the set of upper threshold values are displayed on the second display screen 138 as “Lower Limit” and “Upper Limit”, respectively. In a non-limiting example, the lower limit is $3000/-, 6 Months, 12%, and $200/-for the loan amount, tenure of the loan, the interest rate for the loan, and the processing fee, respectively. The borrower 108 has to enter the plurality of second values referred to as the “desired values” in FIG. 2B such that the plurality of second values are within the set of upper threshold values and the set of lower threshold values. The plurality of second values are entered by the borrower 108 through the second I/O interface 132. Upon entering the plurality of second values, the borrower 108 has to select ‘Proceed’ option presented on the second display screen 138 through the second I/O interface 132.

FIG. 2C represents a pictorial representation of the option to one of accept and reject the plurality of third values of the plurality of loan parameters of the loan rendered on the borrower device 106 of the system environment 100 of FIG. 1 to facilitate automated loan negotiation, in accordance with an exemplary embodiment of the present disclosure.

The option to one of accept and reject the plurality of third values of the plurality of loan parameters of the loan is rendered on the second display screen 138 of the borrower device 106 by the first processor 112. The option is rendered on the second display screen 138 of the borrower device 106 upon the determination of the plurality of third values by the first processor 112 for facilitating automated loan negotiation. A message that indicates “Dear Borrower, please find below the updated values of the loan parameters for the loan” is displayed on the second display screen 138. In a non-limiting example, the plurality of third values of the plurality of loan parameters that include $10,000/-as the loan amount, 12 months as the tenure of the loan, 10% of the loan amount as the rate of interest per annum, and $140/-as the processing fee are displayed on the second display screen 138. Additionally, $890/-as the EMI for the loan is displayed on the second display screen 138. Further, the option to one of accept and negotiate the plurality of third values of the plurality of loan parameters is displayed on the second display screen 138. One of the options is selected by the borrower 108 through the second I/O interface 132.

Although it is described in FIG. 2A-2C that the pictorial representations are rendered on the second display screen 138 of the borrower device 106, the scope of the present disclosure is not limited to it. In other embodiments of the present disclosure, the pictorial representations may be rendered on the first display screen 120 of the negotiation system 102. Additionally, the borrower 108 may select one of the options to accept or negotiate and enter the plurality of second values through the first I/O interface 122 of the negotiation system 102.

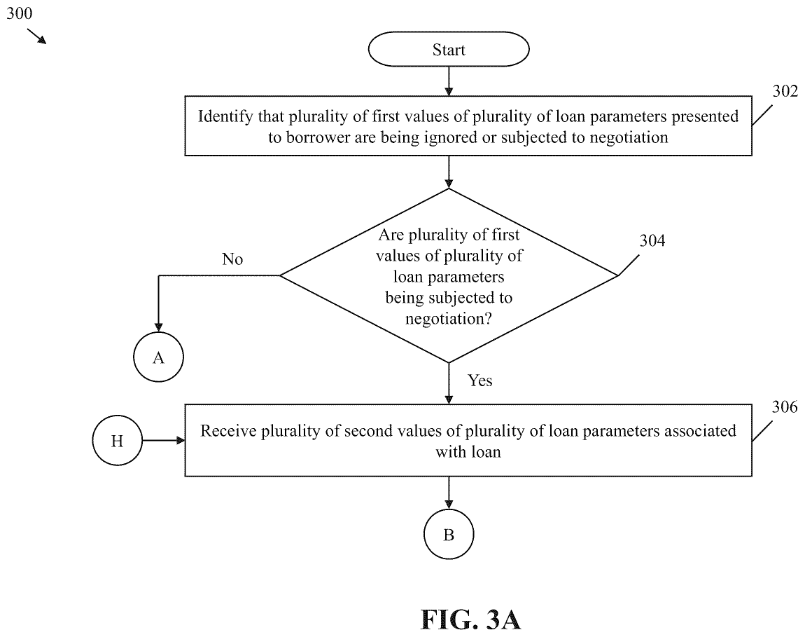

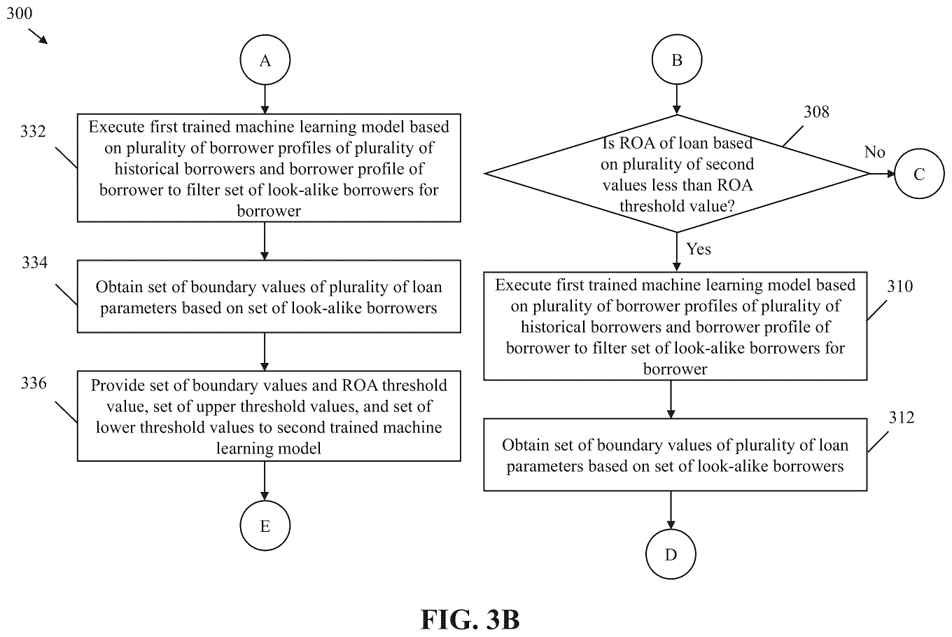

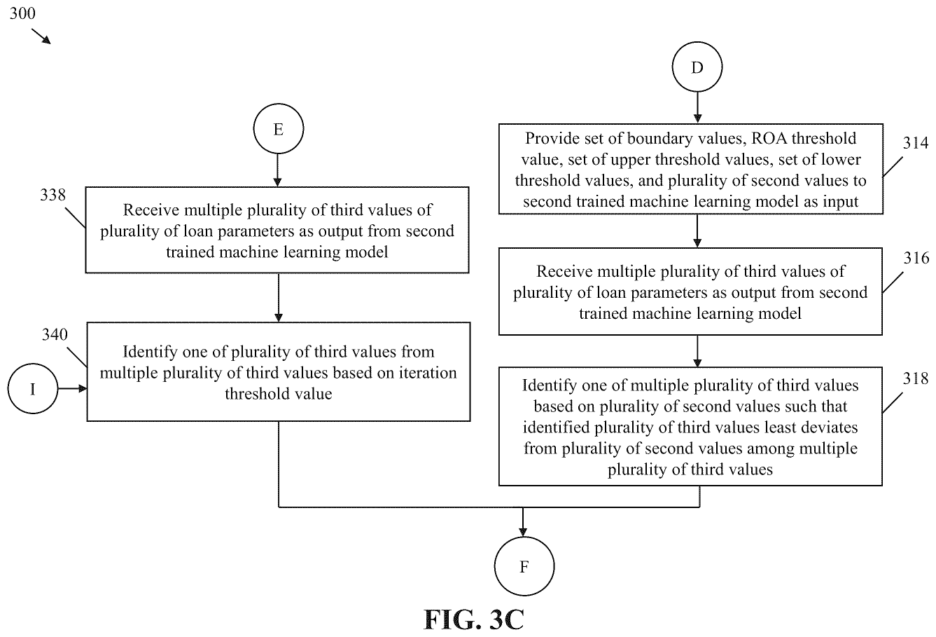

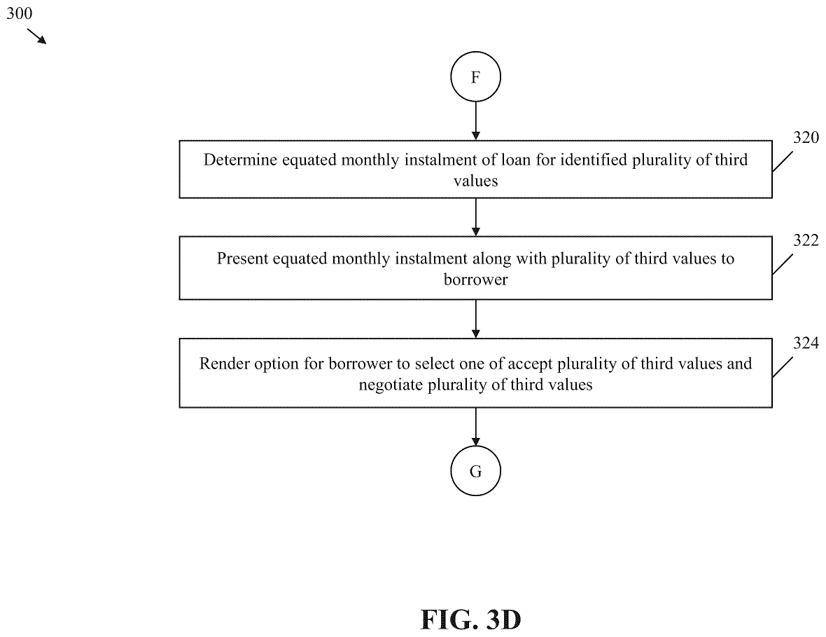

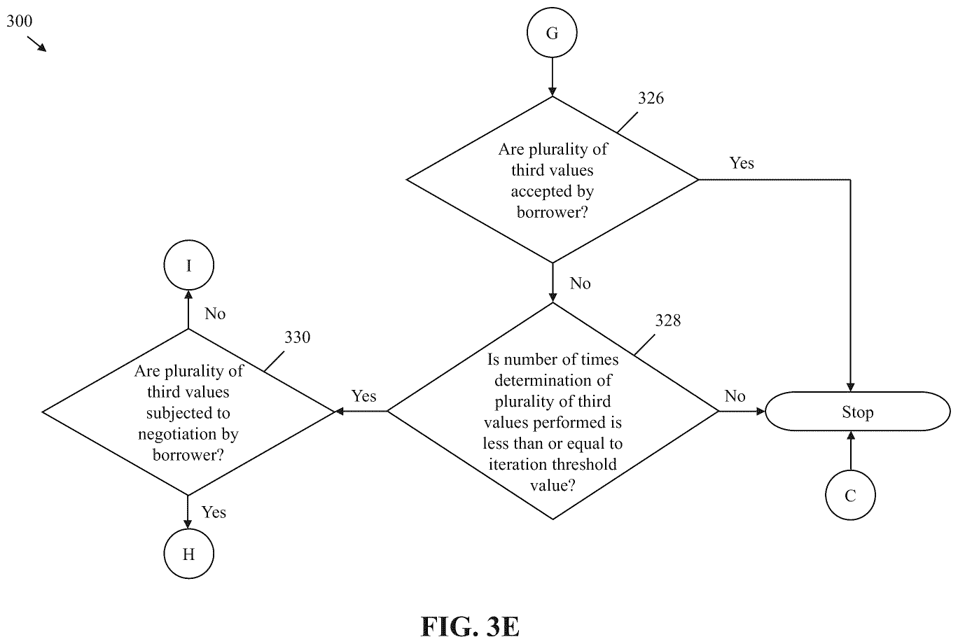

FIGS. 3A-3E, collectively represent a flowchart 300 that illustrates a method (i.e., a process) for automated loan negotiation, in accordance with an exemplary embodiment of the present disclosure.

Referring now to FIG. 3A, the process may start at step 302. At step 302, it is identified that the plurality of first values of plurality of loan parameters presented to borrower 108 are being ignored or subjected to negotiation by the first processor 112. At step 304, it is determined whether the plurality of first values are being subjected to negotiation. If it is determined that the plurality of first values are being subjected to negotiation, the process proceeds to step 306. If it is determined that the plurality of first values are not being subjected to negotiation, the process proceeds to step 332. At step 306, the plurality of second values of the plurality of loan parameters are received by the first processor 112. The plurality of second values are entered by the borrower 108 through the borrower device 106.

Now referring to FIG. 3B, at step 308, it is determined if the ROA of the loan based on the plurality of second values is less than the ROA threshold value. If it is determined that the ROA of the loan is less than the ROA threshold value, the process proceeds to step 310. If it is determined that the ROA of the loan is not less than the ROA threshold value, the process ends. At step 310, the first trained machine learning model 124 is executed by the first processor 112 based on the plurality of borrower profiles of the plurality of historical borrowers and the borrower profile of borrower 108 to filter the set of look-alike borrowers for the borrower 108. At step 312, the set of boundary values of the plurality of loan parameters are obtained by the first processor 112 based on the set of look-alike borrowers.

Now referring to FIG. 3C, at step 314, the set of boundary values, the ROA threshold value, the set upper threshold values, the set of lower threshold values, and the plurality of second values are provided to the second trained machine learning model 126 as an input by the first processor 112. At step 316, the multiple plurality of third values of plurality of loan parameters are received as an output from the second trained machine learning model by the first processor 112. At step 318, one of the multiple plurality of third values is identified by the first processor 112 based on the plurality of second values such that identified plurality of third values least deviates from the plurality of second values among the multiple plurality of third values.

Now referring to FIG. 3D, at step 320, the EMI of the loan for the identified plurality of third values is determined by the first processor 112. At step 322, the EMI of the loan is presented to the borrower 108 by the first processor 112. At step 324, the option to select one of accept the plurality of third values and negotiate the plurality of third values is rendered to the borrower 108.

Now referring to FIG. 3E, at step 326, it is determined by the first processor 112 if the plurality of third values are accepted by the borrower 108. If it is determined that the plurality of third values are accepted by the borrower 108, the process ends. If it is determined that the plurality of third values are not accepted by the borrower 108, the process proceeds to step 328. At step 328, it is determined by the first processor 112 if the number of times the determination of the plurality of third values performed is less than or equal to iteration threshold value. If it is determined that the number of times the determination of the plurality of third values performed is less than or equal to the iteration threshold value, the process proceeds to step 330. If it is determined that the number of times the determination of the plurality of third values performed is not less than or equal to the iteration threshold value, the process ends.

At step 330, it is determined by the first processor 112 if the plurality of third values are subjected to negotiation by the borrower 108. If it is determined that the plurality of third values are being subjected to negotiation, the process proceeds to step 306. If it is determined that the plurality of third values are not being subjected to negotiation, the process proceeds to step 340.

Now referring back to FIG. 3B, the process proceeds to step 332 when it is determined that the plurality of first values are not being subjected to negotiation. At step 332, the first trained machine learning model 124 is executed by the first processor 112 based on the plurality of borrower profiles of the plurality of historical borrowers and the borrower profile of borrower 108 to filter the set of look-alike borrowers for the borrower 108. At step 334, the set of boundary values of the plurality of loan parameters are obtained by the first processor 112 based on the set of look-alike borrowers. At step 336, the set of boundary values, the ROA threshold value, the set upper threshold values, and the set of lower threshold values are provided to the second trained machine learning model 126 as an input by the first processor 112.

Now referring to FIG. 3C, at step 338, the multiple plurality of third values of plurality of loan parameters are received as an output from the second trained machine learning model 126 by the first processor 112. At step 340, one of the plurality of third values from the multiple plurality of third values is identified based on the iteration threshold value and the iteration count value. The process further proceeds to step 320.

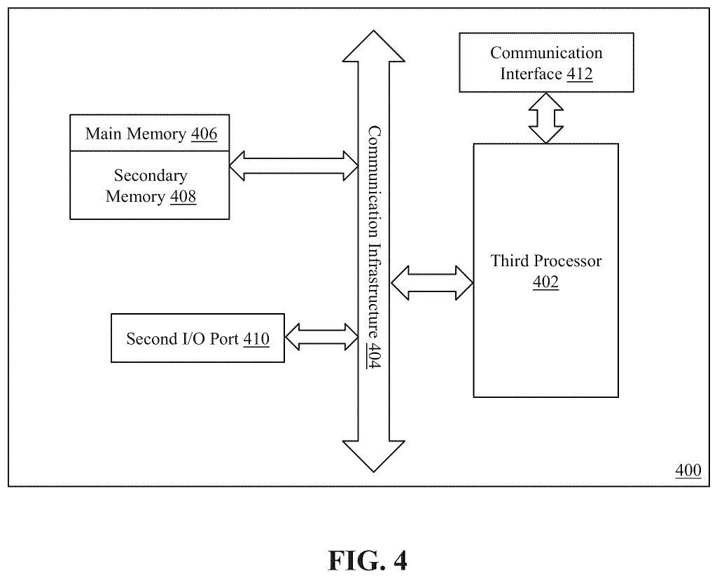

FIG. 4 is a block diagram that illustrates a system architecture of a computer system 400 for automated loan negotiation, in accordance with an exemplary embodiment of the disclosure. An embodiment of the disclosure, or portions thereof, may be implemented as computer-readable code on the computer system 400. In one example, the negotiation system 102 of FIG. 1 may be implemented in the computer system 400 using hardware, software, firmware, a non-transitory computer-readable medium having instructions stored thereon, or a combination thereof, and may be implemented in one or more computer systems or other processing systems. Hardware, software, or any combination thereof may embody modules and components used to implement the method of FIGS. 3A-3E.

The computer system 400 may include a third processor 402 that may be a special-purpose or a general-purpose processing device. The third processor 402 may be a single processor or multiple processors. The third processor 402 may have one or more processor “cores.” Further, the third processor 402 may be coupled to a communication infrastructure 404, such as a bus, a bridge, a message queue, the communication network 110, a multi-core message-passing scheme, or the like. The computer system 400 may further include a main memory 406 and a secondary memory 408. Examples of the main memory 406 may include RAM, ROM, and the like. The secondary memory 408 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer-readable recording medium.

The computer system 400 may further include a second input/output (I/O) port 410 and a communication interface 412. The second I/O port 410 may include various input and output devices that are configured to communicate with the third processor 402. Examples of the input devices may include a keyboard, a mouse, a joystick, a touchscreen, a microphone, and the like. Examples of the output devices may include a display screen, a speaker, headphones, and the like. The communication interface 412 may be configured to allow data to be transferred between the computer system 400 and various devices that are communicatively coupled to the computer system 400. Examples of the communication interface 412 may include a modem, a network interface, i.e., an Ethernet card, a communication port, and the like. Data transferred via the communication interface 412 may be signals, such as electronic, electromagnetic, optical, or other signals as will be apparent to a person skilled in the art. The signals may travel via a communications channel, such as the communication infrastructure 404, which may be configured to transmit the signals to the various devices that are communicatively coupled to the computer system 400. Examples of the communication channel may include wired, wireless, and/or optical media such as cable, fiber optics, a phone line, a cellular phone link, a radio frequency link, and the like. The main memory 406 and the secondary memory 408 may refer to non-transitory computer-readable mediums that may provide data that enables the computer system 400 to implement the method illustrated in FIGS. 3A-3E.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

The disclosed embodiments encompass numerous advantages. The negotiation system 102 implements a method for automated loan negotiation. The negotiation system 102 enables the borrower 108 to efficiently negotiate the plurality of loan parameters. The plurality of modified values of the plurality of loan parameters determined during the automated negotiation are tailored to meet the expectations of the borrower 108. The negotiation system 102 drastically reduces the time consumed for the negotiation in comparison to the conventional negotiation processes. The automated loan negotiation facilitated by the negotiation system 102 eases the negotiation experience of the borrower 108.

Techniques consistent with the disclosure provide, among other features, systems, and methods for automated loan negotiation. While various exemplary embodiments of the disclosed systems and methods have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A method, comprising:
identifying, by a processor of a system, whether a plurality of first values of a plurality of loan parameters associated with a loan, presented to a borrower are being one of (i) ignored and (ii) subjected to negotiation, wherein the processor receives a plurality of second values of the plurality of loan parameters from a device of the borrower when the plurality of first values of the plurality of loan parameters presented to the borrower are subjected to negotiation; and
iteratively determining, by the processor, to negotiate, a plurality of third values of the plurality of loan parameters until one of (i) the plurality of third values are accepted by the borrower and (ii) a number of times the determination of the plurality of third values performed is less than or equal to an iteration threshold value, wherein the plurality of third values corresponding to each of the iteratively performed determinations are unique, wherein the plurality of third values determined in each iteration are rendered to the borrower to enable the borrower to select one of (i) accept the plurality of third values and (ii) negotiate the plurality of third values, and wherein a first determination of the iteratively performed determinations is based on one of
(i) a return on asset (ROA) threshold value, the plurality of second values of the plurality of loan parameters received from the device of the borrower, a set of upper threshold values associated with the plurality of loan parameters, a set of lower threshold values associated with the plurality of loan parameters, a borrower profile of the borrower, and a plurality of borrower profiles of a plurality of historical borrowers stored in a memory element of the system, upon the identification that the plurality of first values are subjected to negotiation and an ROA value for the plurality of second values being less than the ROA threshold value, and
(ii) the ROA threshold value, the set of upper threshold values associated with the plurality of loan parameters, the set of lower threshold values associated with the plurality of loan parameters, the borrower profile of the borrower, and the plurality of borrower profiles of the plurality of historical borrowers, upon the identification that the plurality of first values are ignored by the borrower.

2. The method of claim 1, wherein the determination of the plurality of third values of the plurality of loan parameters upon the identification that the plurality of first values are subjected to negotiation, comprises:
executing, by the processor, a first trained machine learning model based on the plurality of borrower profiles of the plurality of historical borrowers and the borrower profile of the borrower, to filter a set of look-alike borrowers for the borrower;
obtaining, by the processor, a set of boundary values of the plurality of loan parameters, based on the set of look-alike borrowers;
providing, by the processor, the set of boundary values, the ROA threshold value, the set of upper threshold values, the set of lower threshold values, and the plurality of second values, to a second trained machine learning model associated with the system, as an input;
receiving, by the processor, multiple plurality of third values of the plurality of loan parameters as an output from the second trained machine learning model, wherein the second trained machine learning model generates the multiple plurality of third values based on the input received from the processor; and
identifying, by the processor, the plurality of third values from the multiple plurality of third values based on the plurality of second values, wherein the identified plurality of third values are least deviated from the plurality of second values among the multiple plurality of third values.

3. The method of claim 1, wherein the determination of the plurality of third values of the plurality of loan parameters for the first determination upon the identification that the plurality of first values are ignored, comprises:
executing, by the processor, a first trained machine learning model based on the plurality of borrower profiles of the plurality of historical borrowers and the borrower profile of the borrower, to filter a set of look-alike borrowers for the borrower;
obtaining, by the processor, a set of boundary values of the plurality of loan parameters, based on the set of look-alike borrowers;
providing, by the processor, the set of boundary values, the ROA threshold value, the set of upper threshold values, and the set of lower threshold values, to a second trained machine learning model associated with the system, as an input;
receiving, by the processor, multiple plurality of third values of the plurality of loan parameters as an output from the second trained machine learning model, wherein the second trained machine learning model generates the plurality of third values based on the input received from the processor; and
identifying, by the processor, the plurality of third values from the multiple plurality of third values based on the iteration threshold value and an iteration count value, wherein the iteration count value of each determination of the iteratively performed determinations indicates an iteration number associated with the corresponding iteration.

4. The method of claim 3, wherein the determination of the plurality of third values of the plurality of loan parameters after the first determination upon the identification that the plurality of first values are ignored, comprises:
identifying, by the processor, the plurality of third values among the multiple plurality of third values based on the iteration threshold value and the iteration count value.

5. The method of claim 1, further comprising:
receiving, by the processor, the plurality of second values from the device of the borrower when the plurality of first values of the plurality of loan parameters presented to the borrower are subjected to negotiation, wherein the received plurality of second values are within the set of upper threshold values associated with the plurality of loan parameters and the set of lower threshold values associated with the plurality of loan parameters, and wherein the set of upper threshold values and the set of lower threshold values are based on the borrower profile of the borrower.

6. The method of claim 1, wherein the plurality of loan parameters include at least two of a loan amount, a tenure of the loan, an interest rate for the loan, and a processing fee associated with the loan.

7. The method of claim 1, further comprising:
determining, by the processor, the iteration threshold value based on the plurality of borrower profiles of the plurality of historical borrowers and the borrower profile of the borrower.

8. The method of claim 1, further comprising:
determining, by the processor, an equated monthly installment (EMI) of the loan for the plurality of third values upon the determination of the plurality of third values;
presenting, by the processor, the EMI along with the plurality of third values to the borrower; and
rendering, by the processor, an option for the borrower to select one of (i) accept the plurality of third values and (ii) negotiate the plurality of third values.

9. The method as claimed in claim 1, wherein the borrower profile of the borrower includes a set of profile parameters, and wherein the set of profile parameters includes one or more of a cash flow statement, business type, credit history, industry type, demographics, and credit score.

10. A system, comprising:
a memory element configured to store a plurality of borrower profiles of a plurality of historical borrowers; and
a processor configured to:
identify whether a plurality of first values of a plurality of loan parameters associated with a loan, presented to a borrower are being one of (i) ignored and (ii) subjected to negotiation, wherein the processor receives a plurality of second values of the plurality of loan parameters from a device of the borrower when the plurality of first values of the plurality of loan parameters presented to the borrower are subjected to negotiation; and
iteratively determine, to negotiate, a plurality of third values of the plurality of loan parameters until one of (i) the plurality of third values are accepted by the borrower and (ii) a number of times the determination of the plurality of third values performed is less than or equal to an iteration threshold value, wherein the plurality of third values corresponding to each of the iteratively performed determinations are unique, wherein the plurality of third values determined in each iteration are rendered to the borrower to enable the borrower to select one of (i) accept the plurality of third values and (ii) negotiate the plurality of third values, and wherein a first determination of the iteratively performed determinations is based on one of
(i) a return on asset (ROA) threshold value, the plurality of second values of the plurality of loan parameters received from the device of the borrower, a set of upper threshold values associated with the plurality of loan parameters, a set of lower threshold values associated with the plurality of loan parameters, a borrower profile of the borrower, and the plurality of borrower profiles of the plurality of historical borrowers, upon the identification that the plurality of first values are subjected to negotiation and an ROA value for the plurality of second values being less than the ROA threshold value, and
(ii) the ROA threshold value, the set of upper threshold values associated with the plurality of loan parameters, the set of lower threshold values associated with the plurality of loan parameters, the borrower profile of the borrower, and the plurality of borrower profiles of the plurality of historical borrowers, upon the identification that the plurality of first values are ignored by the borrower.

11. The system of claim 10, wherein the memory element is further configured to store a first trained machine learning model and a second trained machine learning model, and wherein to determine the plurality of third values of the plurality of loan parameters upon the identification that the plurality of first values are subjected to negotiation, the processor is further configured to:
execute the first trained machine learning model on the plurality of borrower profiles of the plurality of historical borrowers and the borrower profile of the borrower, to filter a set of look-alike borrowers for the borrower;
obtain a set of boundary values of the plurality of loan parameters, based on the set of look-alike borrowers;
provide the set of boundary values, the ROA threshold value, the set of upper threshold values, the set of lower threshold values, and the plurality of second values, to the second trained machine learning model, as an input;
receive multiple plurality of third values of the plurality of loan parameters as an output from the second trained machine learning model, wherein the second trained machine learning model generates the multiple plurality of third values based on the input received from the processor; and
identify the plurality of third values from the multiple plurality of third values based on the plurality of second values, wherein the identified plurality of third values are least deviated from the plurality of second values among the multiple plurality of third values.

12. The system of claim 10, wherein the memory element is further configured to store a first trained machine learning model and a second trained machine learning model, and wherein to determine the plurality of third values of the plurality of loan parameters for a first iteration of the iteratively performed determinations, upon the identification that the plurality of first values are ignored, the processor is further configured to:
execute the first trained machine learning model based on the plurality of borrower profiles of the plurality of historical borrowers and the borrower profile of the borrower, to filter a set of look-alike borrowers for the borrower;
obtain a set of boundary values of the plurality of loan parameters, based on the set of look-alike borrowers;
provide the set of boundary values the ROA threshold value, the set of upper threshold values, and the set of lower threshold values, to the second trained machine learning model, as an input;
receive multiple plurality of third values of the plurality of loan parameters as an output from the second trained machine learning model, wherein the second trained machine learning model generates the plurality of third values based on the input received from the processor; and
identify the plurality of third values from the multiple plurality of third values based on the iteration threshold value and an iteration count value, wherein the iteration count value of each determination of the iteratively performed determinations indicates an iteration number associated with the corresponding iteration.

13. The system of claim 12, wherein to determine the plurality of third values of the plurality of loan parameters after the first iteration of the iteratively performed determinations, the processor is further configured to:
identify the plurality of third values among the multiple plurality of third values based on the iteration threshold value and the iteration count value.

14. The system of claim 10, wherein the processor is further configured to:
receive the plurality of second values from the device of the borrower when the plurality of first values of the plurality of loan parameters presented to the borrower are subjected to negotiation, wherein the received plurality of second values are within the set of upper threshold values associated with the plurality of loan parameters and the set of lower threshold values associated with the plurality of loan parameters, and wherein the set of upper threshold values and the set of lower threshold values are based on the borrower profile of the borrower.

15. The system of claim 10, wherein the plurality of loan parameters include at least two of a loan amount, a tenure of the loan, an interest rate for the loan, and a processing fee associated with the loan.

16. The system of claim 10, wherein the processor is further configured to:
determine the iteration threshold value based on the plurality of borrower profiles of the plurality of historical borrowers and the borrower profile of the borrower.

17. The system of claim 10, wherein the processor is further configured to:
determine an equated monthly installment (EMI) of the loan for the plurality of third values upon the determination of the plurality of third values;
present the EMI along with the plurality of third values to the borrower; and
render an option for the borrower to select one of (i) accept the plurality of third values and (ii) negotiate the plurality of third values.

18. The system as claimed in claim 10, wherein the borrower profile of the borrower includes a set of profile parameters, and wherein the set of profile parameters includes one or more of a cash flow statement, business type, credit history, industry type, demographics, and credit score.
